(19) United States
(12) Patent Application Publication
(10) Pub. No.: US 2008/0218080 A1
(43) Pub. Date: Sep. 11, 2008

(54) Plasma display panel

(76) Inventors: Jung-Suk Song, Suwon-si (KR); Ki-Dong Kim, Suwon-si (KR); Sang-Hyun Kim, Suwon-si (KR); Bo-Won Lee, Suwon-si (KR); Seong-Hun Choo, Suwon-si (KR); Joon-Hyeong Kim, Suwon-si (KR); Young-Soo Seo, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/901,026

(22) Filed: Sep. 14, 2007

(30) Foreign Application Priority Data
Mar. 5, 2007 (KR) 10-2007-0021552

(51) Int. Cl. H01J 17/49

(52) U.S. Cl. 313/582

(57) ABSTRACT

Provided is a plasma display panel including: a first substrate and a second substrate facing each other; an upper dielectric layer formed on the inner surface of the first substrate; and a first ceramic layer which has about the same thermal expansion coefficient as the upper dielectric layer, faces the upper dielectric layer, and is formed on the outer surface of the first substrate. Alternatively, the plasma display panel includes: a first lower dielectric layer formed on the second substrate and having a thermal expansion coefficient greater than that of the second substrate by α; and a second lower dielectric layer formed on the first lower dielectric layer and having a thermal expansion coefficient less than that of the second substrate by α.

### CROSS-REFERENCE TO RELATED PATENT APPLICATION

This application claims the benefit of Korean Patent Application No. 10-2007-0021552, filed on Mar. 5, 2007, in the Korean Intellectual Property Office, the disclosure of which is incorporated herein in its entirety by reference.

### BACKGROUND OF THE INVENTION

1. Field of the Invention

The present embodiments relate to a plasma display panel that can prevent damage and breakage of a substrate caused by a thermal expansion coefficient difference between the substrate and a dielectric layer.

2. Description of the Related Art

Plasma display panels display an image via a gas discharge and have excellent displaying capability in terms of brightness, contrast, latent image, and viewing angle. In addition, a large and thin screen can be embedded in plasma display panels. Thus, plasma display panels are highly expected to become the next generation of large-sized display panels.

In general, a plasma display panel includes a first substrate and a second substrate that face each other, and a dielectric layer is formed on one of the first and second substrates so as to induce electric charges. The dielectric layer has a thermal expansion coefficient different from that of the substrate on which it is formed. As a result, when an image is formed and thus power consumption increases, heat generation of the plasma display panel increases. Hence, due to the thermal expansion coefficient difference, the substrate on which the dielectric layer is formed may bend. Further, if this substrate is made of glass, the substrate may break. The current embodiments provide plasma display panels that overcome these as well as other disadvantages.

### SUMMARY OF THE INVENTION

The present embodiments provide a plasma display panel in which substrates are protected against bending or breakage.

According to an aspect of the present embodiments, there is provided a plasma display panel comprising: a first substrate and a second substrate facing each other; an upper dielectric layer formed on the inner surface of the first substrate; a first ceramic layer which has about the same thermal expansion coefficient as the upper dielectric layer, faces the upper dielectric layer, and is formed on the outer surface of the first substrate; a plurality of barrier ribs which are disposed between the first and the second substrates and defines a plurality of discharge cells; and a plurality of discharge electrodes disposed such that a discharge occurs in each of the discharge cells. The first ceramic layer may weaken a stress exerted on the first substrate generated due to a thermal expansion coefficient difference between the first substrate and the upper dielectric layer.

In the aforementioned aspect of the present embodiments, the plasma display panel may further comprise: a lower dielectric layer formed on the inner surface of the second substrate; and a second ceramic layer which has about the same thermal expansion coefficient as the lower dielectric layer, faces the lower dielectric layer, and is formed on the outer surface of the second substrate. The second ceramic layer may weaken a stress exerted on the second substrate generated due to a thermal expansion coefficient difference between the second substrate and the lower dielectric layer.

In addition, the first ceramic layer may have a permittivity of 1. Further, the second ceramic layer may have a permittivity of 1. This is because a distortion of a signal supplied to the electrodes can be prevented by the ceramic layers.

In addition, the discharge electrodes may be formed on the first substrate and may include a transparent electrode and a bus electrode through which a voltage is supplied to produce a sustain discharge in the discharge cells.

In addition, the plasma display panel may further comprise an address electrode which is formed on the second substrate and through which a voltage is supplied to produce an address discharge for selecting the discharge cells.

In addition, the plasma display panel may further comprise a phosphor layer formed on the barrier rib.

In addition, the plasma display panel may further comprise a passivation layer formed on the upper dielectric layer.

According to another aspect of the present embodiments, there is provided a plasma display panel comprising: a first substrate and a second substrate facing each other; a first lower dielectric layer formed on the second substrate and having a thermal expansion coefficent greater than that of the second substrate by α; a second lower dielectric layer formed on the first lower dielectric layer and having a thermal expansion coefficient less than that of the second substrate by α; a plurality of barrier ribs which are disposed between the first and second substrates and define a plurality of discharge cells; and a plurality of discharge electrodes disposed such that a discharge occurs in each of the discharge cells.

In the aforementioned aspect of the present embodiments, the second substrate may be first formed, followed by the first lower dielectric layer formed on the second substrate, and the second lower dielectric layer formed on the first lower dielectric layer.

Alternatively, the second substrate may be first formed, followed by the second lower dielectric layer formed on the second substrate, and the first lower dielectric layer formed on the second lower dielectric layer.

In addition, the plasma display panel may further comprise: a first upper dielectric layer formed on the first substrate and having a thermal expansion coefficient greater than that of the first substrate by β; and a first upper dielectric layer formed on the first upper dielectric layer and having a thermal expansion coefficient less than that of the first substrate by β.

In addition, the first substrate may be first formed, followed by the first upper dielectric layer formed on the first substrate, and the second upper dielectric layer formed on the first upper dielectric layer.

Alternatively, the first substrate may be first formed, followed by the second upper dielectric layer formed on the first substrate, and the first upper dielectric layer formed on the second upper dielectric layer.

According to another aspect of the present embodiments, there is provided a plasma display panel comprising: a first substrate and a second substrate facing each other; an upper dielectric layer formed on the inner surface of the first substrate; a first ceramic layer which has about the same thermal expansion coefficient as the upper dielectric layer, faces the upper dielectric layer, and is formed on the outer surface of the first substrate; a first lower dielectric layer formed on the second substrate and having a thermal expansion coefficient greater than that of the second substrate by α; a second lower dielectric layer formed on the first lower dielectric layer and having a thermal expansion coefficient less than that of the second substrate by α; a plurality of barrier ribs which are disposed between the first and second substrates and defines a plurality of discharge cells; and a plurality of discharge electrodes disposed such that a discharge occurs in each of the discharge cells.

In the aforementioned aspect of the present embodiments, the first ceramic layer may have about the same permittivity as the upper dielectric layer.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a cross-sectional view of a plasma display panel according to an embodiment;

FIG. 2 is a cross-sectional view of a plasma display panel according to another embodiment;

FIG. 3 is an exploded perspective view of a plasma display panel according to another embodiment;

FIG. 4 is a cross-sectional view of a plasma display panel which serves as a control group and does not include a ceramic layer and lower dielectric layers each having a different thermal expansion coefficient;

FIG. 5 is a graph illustrating a stress distribution of a first substrate of the plasma display panel of FIG. 4;

FIG. 6 is a graph illustrating a stress distribution of a second substrate of the plasma display panel of FIG. 4;

FIG. 7 is a graph illustrating a stress distribution of a first substrate of the plasma display panel of FIG. 1 according to an embodiment;

FIGS. 8 to 10 are graphs each illustrating a stress distribution of a second substrate of the plasma display panel of FIG. 2 according to another embodiment; and

FIG. 11 is a graph illustrating a stress distribution of a first substrate of the plasma display panel according to another embodiment.

### DETAILED DESCRIPTION OF THE INVENTION

Hereinafter, exemplary embodiments will be described in detail with reference to the accompanying drawings.

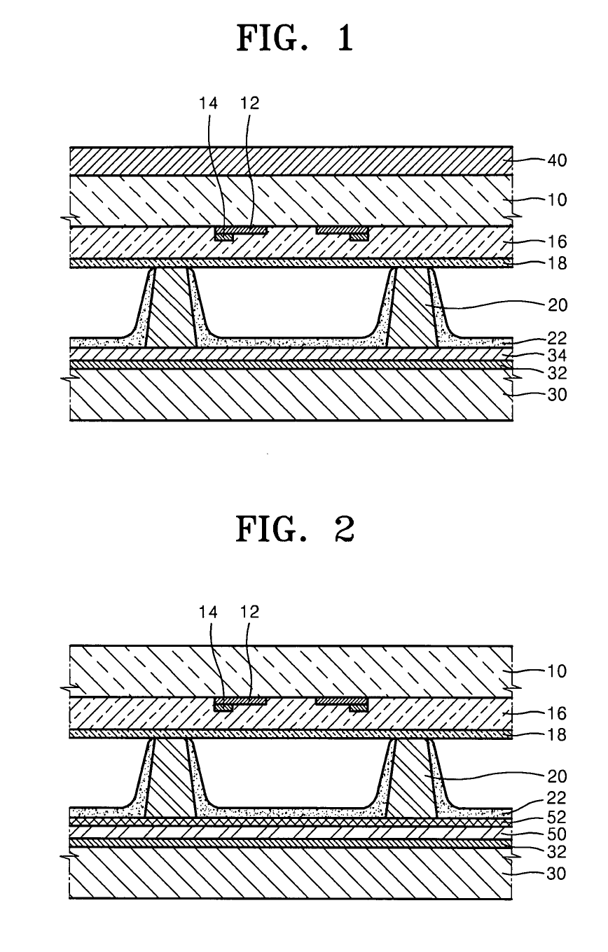

FIG. 1 is a cross-sectional view of a plasma display panel according to an embodiment. In the present embodiment, the plasma display panel has a three-electrode surface discharge structure. However, the present embodiments are not limited thereto.

Referring to FIG. 1, the plasma display panel includes a first substrate 10 and a second substrate 30, which face each other. The first substrate 10 is made of a material having an excellent optical transmission property. One example of a possible principal component of the material is glass. Likewise, the second substrate 30 may be also made of glass, for example. In addition, the second substrate 30 may be colored in order to improve actual contrast by reducing reflective brightness.

Barrier ribs 20 are disposed between the first substrate 10 and the second substrate 30 so as to define discharge cells. A plurality of discharge electrodes are respectively disposed inside the discharge cells. The discharge electrodes include a transparent electrode 12 capable of transmitting light and formed wide in length and a bus electrode 14 having an excellent electrical conductivity. The transparent electrode 12 and the bus electrode 14 may be formed on the first substrate 10. Furthermore, an address electrode 32 is formed on the second substrate 30.

An upper dielectric layer 16 is formed at the inner surface the first substrate 10 so as to cover the discharge electrodes. A passivation layer 18 is further provided in order to protect the upper dielectric layer 16 against damage caused by charged particles when a discharge occurs. The passivation layer 18 emits secondary electrons to decrease a discharge voltage. The passivation layer 18 may be formed, for example by the depositing of magnesium oxide (MgO).

The upper dielectric layer 16 prevents adjacent discharge electrodes from being electrically conducted with each other. Further, the upper dielectric layer 16 protects the discharge electrodes against damage when the charged particles directly collide with the discharge electrodes. Furthermore, the upper dielectric layer 16 induces electric charges. The upper dielectric layer 16 may be made of, for example, PbO, B₂O₃, or SiO₂. In addition, the upper dielectric layer 16 may further include at least one ferroelectric material such as, for example, (Pa, La)—(ZrTi)O₃, (Pa, Bi)—(ZrTi)O₃, (Pa, La)—(HfTi)O₃, (Pa, Ba)(ZrTi)O₃, (Pa, Sr)—(ZrTi)O₃, (Sr, Ca)—(LiNbTi)O₃, LiTaO₃, SrTiO₃, La₂Ti₂O₇, LiNbO₃, (Pa, La)—(MgNbZrTi)O₃, (Pa, Ba)—(LaNb)O₃, (Sr, Ba)—Mb₂O₃, K(Ta, Nb)O₃, (Sr, Ba, La)—(Nb₂O₆), NaTiO₃, MgTiO₃, BaTiO₃, SrZrO₃, or KNbO₃. The ferroelectric material has an electric polarization property in a nature state. When a voltage pulse is supplied, a large quantity of electrons are emitted from the surface of the ferroelectric material. Since the electrons are emitted from the ferroelectric material when the voltage pulse is externally supplied to the discharge electrodes, the quantity of electrons increases within the discharge cells, thereby activating a plasma discharge. As the plasma discharge is activated, vacuum ultraviolet rays are generated in large quantities. Thus, brightness and emission efficiency are improved.

A ceramic layer 40 having almost the same thermal expansion coefficient as the upper dielectric layer 16 is formed on the outer surface of the first substrate 10. In general, if the temperature rises due to a thermal expansion coefficient difference between the first substrate 10 and the upper dielectric layer 16, the first substrate 10 may bend or break. The purpose of the ceramic layer 40 is to prevent such a situation.

For example, if the first substrate 10 is a glass substrate having a thermal expansion coefficient of about 85×10⁻⁷/° C., and the upper dielectric layer 16 has a thermal expansion coefficient of about 80×10⁻⁷/° C., then the ceramic layer 40 may be formed by applying a ceramic material having a thermal expansion coefficient of about 80×10⁻⁷/° C. Due to the thermal expansion coefficient difference between the first substrate. 10 and the upper dielectric layer 16, an expansion stress exerted on the glass substrate is stronger than the that on the upper dielectric layer 16. As a result, the glass substrate may bend towards the upper dielectric layer 16 or may break. However, since the ceramic layer 40 is formed on the outer surface of the first substrate 10, the stress that bends the first substrate 10 towards the upper dielectric layer 16 is weakened by the stress that bends the first substrate 10 towards the ceramic layer 40. Therefore, the first substrate 10 can be protected against bending or breakage.

The ceramic layer 40 may have a permittivity of about 1. This is because a signal supplied to the discharge electrodes may be distorted by the ceramic layer 40.

In the case of a top emission plasma display panel, an image is formed by transmitting light through the first substrate 10. Therefore, the ceramic layer 40 formed on the first substrate 10 should be made of a transparent material so that light can be transmitted therethrough. The ceramic layer 40 may have a uniform thickness in order to avoid image distortion. Accordingly, the ceramic layer 40 may be formed by attaching a sheet made of the same ceramic material as the upper dielectric layer 16.

The ceramic layer 40 may be also formed on the outer surface of the second substrate 30 so as to protect the second substrate 30 against bending or breakage.

The address electrode 32 is formed on the second substrate 30. Further, a lower dielectric layer 34 is formed to cover the address electrode 32. A phosphor layer 22 is applied on the lower dielectric layer 34 and the barrier rib 20.

The phosphor layer 22 receives ultraviolet rays to generate a visible light beam. A red light emitting phosphor material may be Y(V,P)O₄:Eu. A green light emitting phosphor material may be Zn₂SiO₄:Mn or YBO₃:Tb. A blue light emitting phosphor material may be BAM:Eu.

A discharge gas (e.g., Ne, Xe, or a gas mixture of Ne and Xe) is injected in the discharge cells defined by the barrier ribs 20.

FIG. 2 is a cross-sectional view of a plasma display panel according to another embodiment.

Referring to FIG. 2, the plasma display panel includes a first substrate 10 and a second substrate 30, facing each other. Further, barrier ribs 20 are formed between the first and second substrates 10 and 30 so as to define discharge cells. As shown in FIG. 1, a transparent electrode 12 and a bus electrode 14 are disposed at the inner surface of the first substrate 10. Further, an upper dielectric layer 16 is formed to cover the electrodes 12 and 14. A passivation layer 18 is formed on the upper dielectric layer 16.

An address electrode 32 is formed on the second substrate 30. Further, a lower dielectric layer is formed to cover the address electrode 32.

During a discharge, the lower dielectric layer protects the address electrode 32 against damage when electric charges collide with the address electrode 32. The lower dielectric layer is made of a dielectric material capable of inducing the electric charges. Examples of the dielectric material include PbO, B₂O₃, and SiO₂.

In the present embodiment, the lower dielectric layer protects the second substrate 30 against bending or breakage. The lower dielectric layer includes first and second lower dielectric layers 50 and 52 each having a different thermal expansion coefficient.

The first and second lower dielectric layers 50 and 52 are sequentially formed on the second substrate 30 so as to cover the address electrode 32.

The first lower dielectric layer 50 has a thermal expansion coefficient greater than that of the second substrate 30 by about α. The second lower dielectric layer 52 has a thermal expansion coefficient less than that of the second substrate 30 by about α. Therefore, a stress produced by the thermal expansion coefficient difference between the second substrate 30 and the first lower dielectric layer 50 can be weakened by the second lower dielectric layer 52. The second lower dielectric layer 52 may be first formed on the second substrate 30, followed by the first lower dielectric layer 50.

If the second substrate 30 is a glass substrate having a thermal expansion coefficient of about 85×10⁷/° C., and the first lower dielectric layer 50 has a thermal expansion coefficient of about 90×10⁻⁷/° C., a thermal expansion coefficient difference between the first lower dielectric layer 50 and the second substrate 30 is 5×10⁻⁷/° C. Due to this difference, a stress is exerted on the second substrate 30 so that the second substrate 30 is bent towards the outer surface of the second substrate 30. However, the stress can be weakened by the second lower dielectric layer 52. If the second lower dielectric layer 52 has a thermal expansion coefficient of about 80×10⁻⁷/° C. that is less than that of the second substrate 30 by 5×10⁻⁷/° C., the stress exerted on the second substrate 30 can be compensated for by a stress which is exerted by the second substrate 30 towards the second lower dielectric layer 52 due to the thermal expansion coefficient difference between the second substrate 30 and the second lower dielectric layer 52.

The first and second lower dielectric layers 50 and 52 may be formed on the inner surface of the first substrate 10. In the case of a top emission plasma display, the lower dielectric layers 50 and 52 may be made of a light-transmissive material.

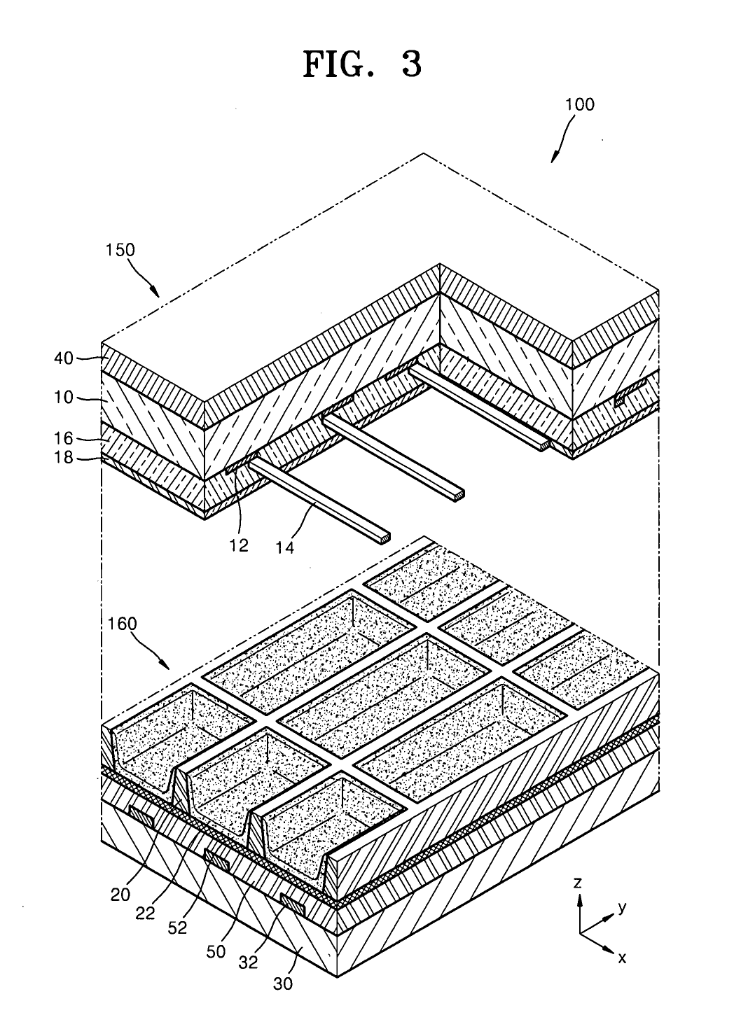

FIG. 3 is an exploded perspective view of a plasma display panel according to another embodiment.

Referring to FIG. 3, a plasma display panel 100 includes an upper panel 150 and a lower panel 160.

In the upper panel 150, a transparent electrode 12 and a bus electrode 14 are formed on the inner surface of a first substrate 10. Further, an upper dielectric layer 16 is formed to cover the electrodes 12 and 14. A passivation layer 18 is formed on the upper dielectric layer 16.

A ceramic layer 40 is formed on the outer surface of the first substrate 10. The ceramic layer 40 has a permittivity of about 1, which is almost the same as the upper dielectric layer 16. Due to the thermal expansion coefficient difference between the ceramic layer 40 and the upper dielectric layer 16, the first substrate 10 can be protected against bending or breakage.

In the lower panel 160, an address electrode 32 is formed on a second substrate 30 to cross the discharge electrodes. Further, a lower dielectric layer is formed to cover the address electrode 32.

The lower dielectric layer includes a first lower dielectric layer 50 having a thermal expansion coefficient greater than that of the second substrate 30 by α and a second lower dielectric layer 52 having a thermal expansion coefficient less than that of the second substrate 30 by α. Therefore, a stress caused by the thermal expansion coefficient difference between the second substrate 30 and the first lower dielectric layer 50 can be weakened by the second lower dielectric layer 52, thereby the second substrate 30 is protected against damage. Although the first and second lower dielectric layers 50 and 52 are sequentially formed on the second substrate 30 in the current embodiment, the present embodiments are not limited thereto. Thus, the lower dielectric layer 52 may be first formed on the second substrate 30, followed by the first lower dielectric layer 50.

Barrier ribs 20 are formed on the lower dielectric layer between the first and second substrates 10 and 30 so as to define the discharge cells. The barrier ribs 20 may have, for example, a stripe structure, a beehive structure, or a matrix structure. In the present embodiment, a horizontal barrier rib and a vertical barrier rib crossing the horizontal barrier rib are provided so as to form discharge cells having a matrix structure.

A phosphor layer 22 is formed on the barrier ribs 20. The phosphor layer 22 receives an ultraviolet ray to generate a visible light beam. The phosphor layer 22 includes a red light emitting phosphor material, a green light emitting phosphor material, and a blue light emitting phosphor material. The red light emitting phosphor material may be Y(V,P)O₄:Eu. The green light emitting phosphor material may be Zn₂SiO₄:Mn or YBO₃:Tb. The blue light emitting phosphor material may be BAM:Eu.

FIG. 4 is a cross-sectional view of a plasma display panel which serves as a control group and does not include a ceramic layer and lower dielectric layers each having a different thermal expansion coefficient.

Referring to FIG. 4, in the plasma display panel, a transparent electrode 12 and a bus electrode 14 are formed on the inner surface of a first substrate 10. Further, an upper dielectric layer 16 is formed to protect the electrodes 12 and 14 against damage caused by charged particles and to induce electric charges. A passivation layer 18 is formed on the upper dielectric layer 16 to protect the upper dielectric layer 16 against damage caused by the charged particles.

An address electrode 32 is formed on the inner surface of a second substrate 30. A lower dielectric layer 34 is formed to protect the address electrode 32 against damage caused by charged particles and to induce electric charges. The upper dielectric layer 16 and the lower dielectric layer 34 are made of PbO, B₂O₃, or SiO₂.

Barrier ribs 20 are formed on the first and second substrates 10 and 30 so as to define discharge cells. The barrier ribs 20 may come in contact with the passivation layer 18 on the first substrate 10 and the lower dielectric layer 34 on the second substrate 30. A phosphor layer 22 is formed in the discharge cells defined by the barrier ribs 20. A discharge gas is injected in the discharge cells.

The first and second substrates 10 and 30 of the plasma display panel shown in FIG. 4 are glass substrates each having a thickness of about 2.8 mm.

The plasma display panel of FIG. 4 does not include a ceramic layer and lower dielectric layers each having a different thermal coefficient and is used as a control group for experiments in order to test the degree of a stress exerted on substrates.

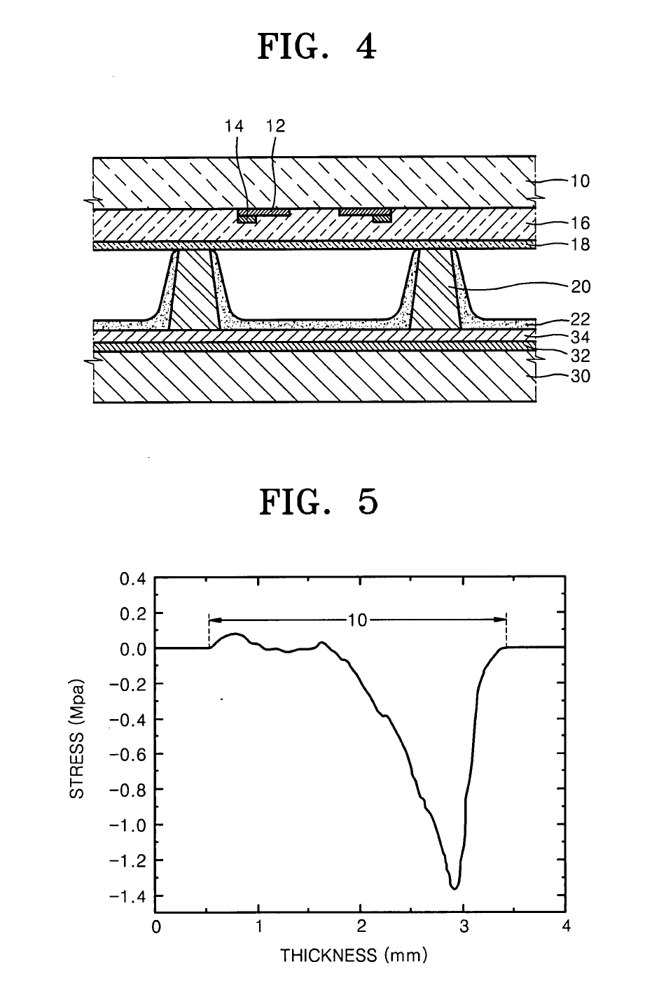

FIG. 5 is a graph illustrating the stress distribution of the first substrate 10 of the plasma display panel of FIG. 4.

According to this embodiment, a stress exerted on the first substrate 10 of the plasma display panel of FIG. 4 will be described.

Referring to FIG. 5, a stress in the range of 0 to −1.4 Mpa is exerted on the first substrate 10. The minus (−) sign denotes a direction of stress, which means that the stress is perpendicular with respect to the cross-section of the first substrate 10 so that the first substrate 10 bends towards its inner surface. Thus, a very strong stress for bending the first substrate 10 towards its inner surface is exerted on the first substrate 10 due to a thermal expansion coefficient difference between the first substrate 10 and the upper dielectric layer 16.

FIG. 6 is a graph illustrating a stress distribution of the second substrate 30 of the plasma display panel of FIG. 4.

Referring to FIG. 6, a strong stress is also exerted on the second substrate 30 due to a thermal expansion coefficient difference between the second substrate 30 and the lower dielectric layer 34. An experiment is carried out with the plasma display panel of FIG. 4 in two cases. In the first case (a), a stress in the range of +0.16 to −1.16 Mpa is exerted on the second substrate 30. In the second case (b), a stress in the range of +0.17 to −1.12 Mpa is exerted on the second substrate 30.

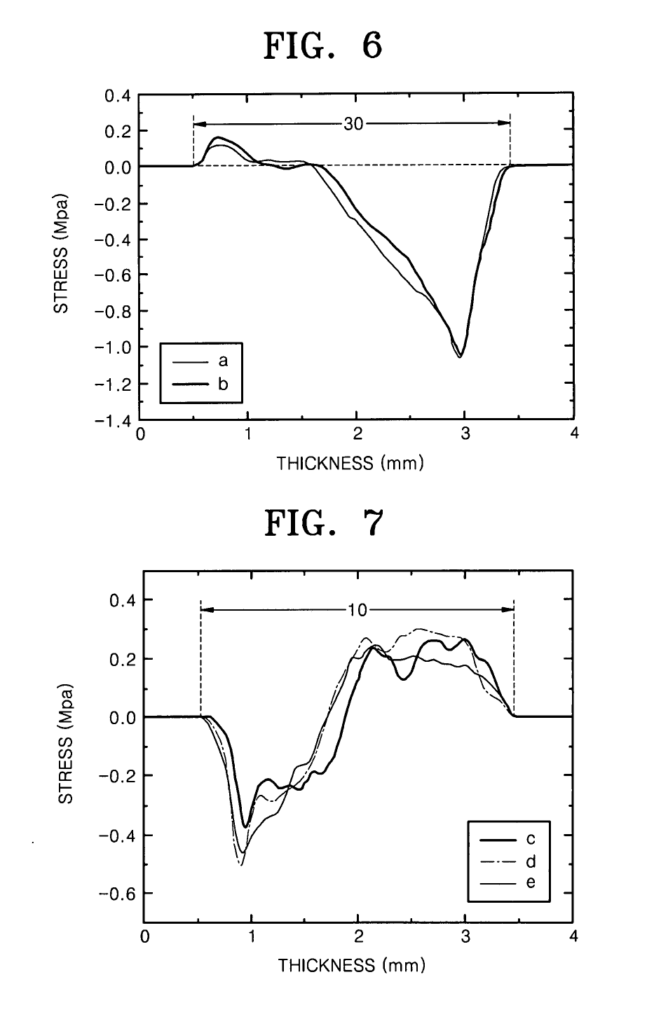

FIG. 7 is a graph illustrating a stress distribution of the first substrate 10 of the plasma display panel of FIG. 1 according to an embodiment.

According to the present embodiment, a stress exerted on the first substrate 10 of the plasma display panel of FIG. 1 is examined. In the plasma display panel of FIG. 1, the ceramic layer 40 is formed on the outer surface of the first substrate 10.

Referring to FIG. 7, three plasma display panels with a 50 HD level are used as experimental devices. In each plasma display panel, the ceramic layer 40, which has a permittivity of about 1 and has about the same thermal expansion layer as the upper dielectric layer 16, is formed on the first substrate 10. Specifically, in the three experimental devices, the first substrate 10 is a glass substrate having a thermal expansion coefficient of about 85×10⁻⁷/° C., the upper dielectric layer 16 has a thermal expansion coefficient of about 80×10⁻⁷/° C., and the ceramic layer 40 has a thermal expansion coefficient of about 80×10⁻⁷/° C.

Experimental devices 1(c), 2(d), and 3(e) (see FIG. 7) have stresses in the range of 0.3 to −0.5. In comparison with the graph of FIG. 5, the stress shown in the graph of FIG. 7 is significantly reduced.

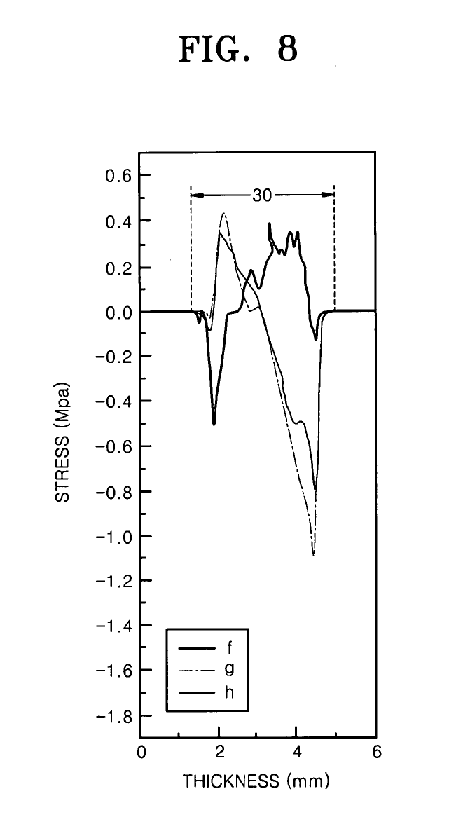

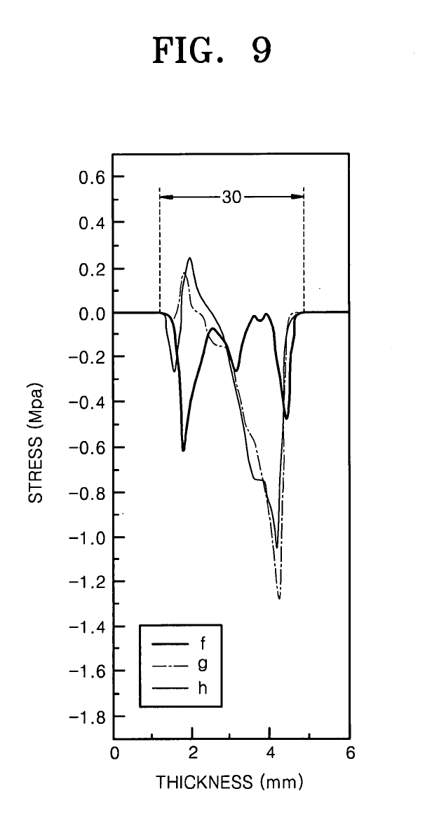

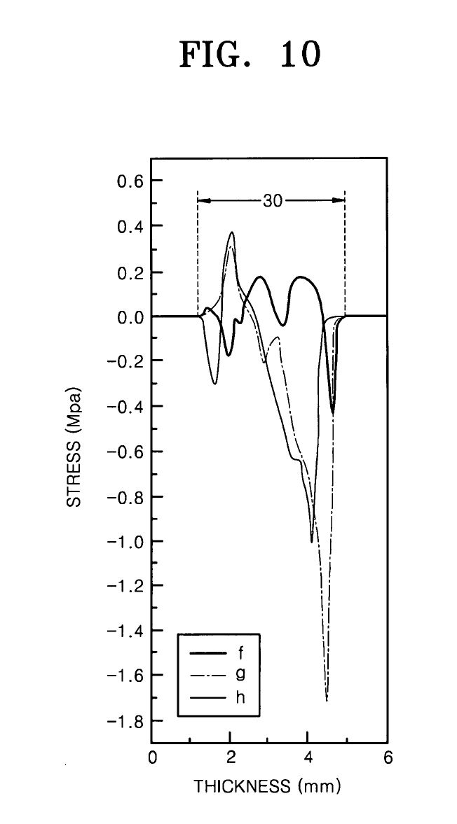

FIGS. 8 to 10 are graphs each illustrating the stress distribution of the second substrate of the plasma display panel of FIG. 2 according to another embodiment.

Referring to FIGS. 8 to 10, a stress of a plasma display panel will be described. In the plasma display panel of FIG. 2, the first lower dielectric layer 50 having a thermal expansion coefficient greater than that of the second substrate 30 by α and the lower dielectric layer 52 having a thermal expansion coefficient less than that of the second substrate 30 by α are formed between the second substrate 30 and the barrier rib 20 in order to protect the second substrate 30 against breakage. Specifically, an experimental device (f) (see FIG. 8) used in the three experiments is a plasma display panel in which the second substrate 30 is a glass substrate having a thermal expansion coefficient of about 85×10⁻⁷/° C., the first lower dielectric layer 50 has a thermal expansion coefficient of about 90×10⁻⁷/° C., and the second lower dielectric layer 52 has a thermal expansion coefficient of about 80×10⁻⁷/° C. As a control group, two of the plasma display panels of FIG. 4 are used which do not include the ceramic layer 40 and the first and second lower dielectric layers 50 and 52. The first device (g) and the second device (h) have a stress in the range of 0.4 to −1.7 Mpa. On the other hand, the experimental device (f) has a stress in the range of 0.4 to −0.6 Mpa. Thus, the stress exerted on the second substrate 30 due to the lower dielectric layers 50 and 52 each having a different thermal expansion coefficient is remarkably reduced.

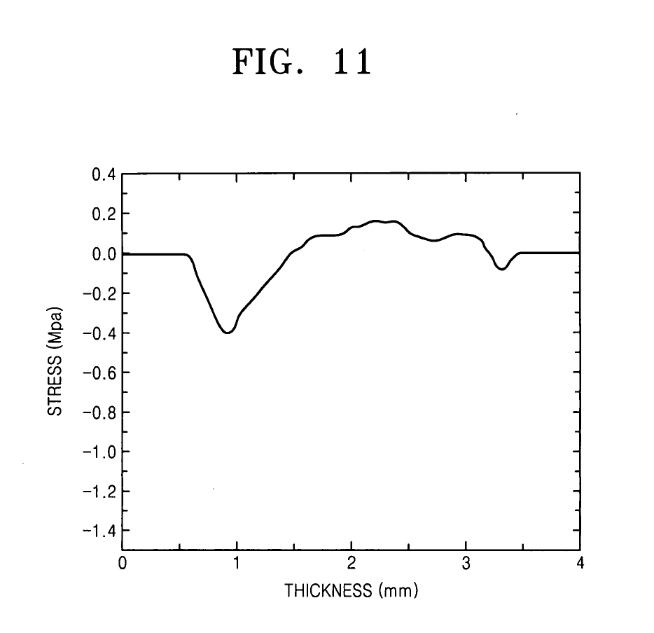

FIG. 11 is a graph illustrating the stress distribution of a first substrate of a plasma display panel according to another embodiment. According to the present embodiment, the plasma display panel comprises a first substrate, a discharge electrode pair on the first substrate, a first upper dielectric layer on the first substrate to cover the discharge electrode pair and the second upper dielectric layer on the first dielectric, and a stress exerted on the first substrate of the plasma display panel is examined using the same method of FIGS. 8-10 Specifically, the first substrate is a glass substrate having a thermal expansion coefficient of about 85×10⁻⁷/° C., the first upper dielectric layer has a thermal expansion coefficient of about 90×10⁻⁷/° C., and the second upper dielectric layer 52 has a thermal expansion coefficient of about 80×10⁻⁷/° C.

Referring to FIG. 11, the stress exerted on the first substrate is about 0.2 to −0.4 Mpa, therefore, the stress of the first substrate is remarkably reduced.

According to the present embodiments, a ceramic layer having about the same thermal expansion coefficient as a dielectric layer is formed on the outer surface of a substrate facing the inner surface of another substrate on which the dielectric layer is formed. Therefore, the substrates can be protected against bending or breakage.

In addition, in a plasma panel display of the present embodiments, a dielectric layer having a thermal expansion coefficient greater than that of a substrate by α and another dielectric layer having a thermal expansion coefficient less than that of the substrate by α are formed on the substrate. Therefore, the substrate can be protected against damage.

While the present embodiments have been particularly shown and described with reference to exemplary embodiments thereof, it will be understood by those skilled in the art that various changes in form and details may be made therein without departing from the spirit and scope of the present embodiments as defined by the appended claims.

What is claimed is:

1. A plasma display panel comprising:
a first substrate and a second substrate facing each other;
an upper dielectric layer formed on the inner surface of the first substrate;
a first ceramic layer with about the same thermal expansion coefficient as the upper dielectric layer, facing the upper dielectric layer, wherein the first ceramic layer is formed on the outer surface of the first substrate;
a plurality of barrier ribs which are disposed between the first and the second substrates and define a plurality of discharge cells; and
a plurality of discharge electrodes disposed such that a discharge occurs in each of the discharge cells.

2. The plasma display panel of claim 1, wherein the first ceramic layer has a permittivity of about 1.

3. The plasma display panel of claim 1, further comprising:
a lower dielectric layer formed on the inner surface of the second substrate; and
a second ceramic layer which has about the same thermal expansion coefficient as the lower dielectric layer, faces the lower dielectric layer, and is formed on the outer surface of the second substrate.

4. The plasma display panel of claim 3, wherein the second ceramic layer has a permittivity of about 1.

5. The plasma display panel of claim 1, wherein the discharge electrodes are formed on the first substrate and include a transparent electrode and a bus electrode through which a voltage is supplied to produce a sustain discharge in the discharge cells.

6. The plasma display panel of claim 1, further comprising an address electrode which is formed on the second substrate and through which a voltage is supplied to produce an address discharge for selecting the discharge cells.

7. The plasma display panel of claim 1, further comprising a phosphor layer formed on the barrier ribs.

8. The plasma display panel of claim 1, further comprising a passivation layer formed on the upper dielectric layer.

9. A plasma display panel comprising:
a first substrate and a second substrate facing each other;
a first lower dielectric layer formed on the second substrate and having a thermal expansion coefficient greater than that of the second substrate by about α;
a second lower dielectric layer formed on the first lower dielectric layer and having a thermal expansion coefficient less than that of the second substrate by about α;
a plurality of barrier ribs which are disposed between the first and second substrates and define a plurality of discharge cells; and
a plurality of discharge electrodes disposed such that a discharge occurs in each of the discharge cells.

10. The plasma display panel of claim 9, wherein the first lower dielectric layer is formed on the second substrate, and the second lower dielectric layer is formed on the first lower dielectric layer.

11. The plasma display panel of claim 9, wherein the second lower dielectric layer is formed on the second substrate, and the first lower dielectric layer is formed on the second lower dielectric layer.

12. The plasma display panel of claim 9, further comprising:
a first upper dielectric layer formed on the first substrate and having a thermal expansion coefficient greater than that of the first substrate by β; and
a second upper dielectric layer formed on the first upper dielectric layer and having a thermal expansion coefficient less than that of the first substrate by β.

13. The plasma display panel of claim 12, wherein the first upper dielectric layer is formed on the first substrate, and the second upper dielectric layer is formed on the first upper dielectric layer.

14. The plasma display panel of claim 12, wherein the second upper dielectric layer is formed on the first substrate, and the second upper dielectric layer is formed on the first upper dielectric layer.

15. A plasma display panel comprising:
a first substrate and a second substrate facing each other;
an upper dielectric layer formed on the inner surface of the first substrate;
a first ceramic layer which has about the same thermal expansion coefficient as the upper dielectric layer, faces the upper dielectric layer, and is formed on the outer surface of the first substrate;
a first lower dielectric layer formed on the second substrate and having a thermal expansion coefficient greater than that of the second substrate by α;
a second lower dielectric layer formed on the first lower dielectric layer and having a thermal expansion coefficient less than that of the second substrate by α;
a plurality of barrier ribs which are disposed between the first and second substrates and define a plurality of discharge cells; and
a plurality of discharge electrodes disposed such that a discharge occurs in each of the discharge cells.

16. The plasma display panel of claim 15, wherein the first ceramic layer has a permittivity of about 1.
